(19) United States
(12) Patent Application Publication
(10) Pub. No.: US 2021/0058845 A1
(43) Pub. Date: Feb. 25, 2021

(54) Communication Method and Network Device

(71) Applicant: GUANGDONG OPPO MOBILE TELECOMMUNICATIONS CORP., LTD., Dongguan (CN)

(72) Inventor: Jianhua Liu, Dongguan (CN)

(21) Appl. No.: 17/091,243

(22) Filed: Nov. 6, 2020

Related U.S. Application Data
(63) Continuation of application No. PCT/CN2018/087149, filed on May 16, 2018.

(51) Int. Cl. H04W 36/38; H04W 36/00; H04W 36/32

(52) U.S. Cl. CPC H04W 36/385; H04W 36/32; H04W 36/0066; H04W 36/00837

(57) ABSTRACT

The embodiments of the present disclosure provide a communication method and a network device. In the embodiments of the present disclosure, a first network device acquires behavior decision information of a terminal, wherein the behavior decision information comprises at least one of terminal capability information of the terminal, service requirement information initiated by the terminal, service quality information initiated by the terminal and user subscription information of the terminal, so that the first network device can send first instruction information to the terminal according to the behavior decision information so as to instruct the terminal to execute a specific mobility process.

### CROSS-REFERENCE TO RELATED APPLICATION(S)

This application is a continuation application of International Application No. PCT/CN2018/087149, filed on May 16, 2018, the entire disclosure of which is hereby incorporated by reference.

### TECHNICAL FIELD

The present disclosure relates to wireless communication technology, in particular to a communication method and a network device.

### BACKGROUND

With the rapid development of wireless network communication technology, wireless communication network has gradually entered a 5G era. In the 5G era, the User Equipment (UE) can not only access the 5G core network, namely, the Next Generation Core Network (NGCN), through the Next Generation-Radio Access Network (NG-RAN) but also access a 4G core network, namely, the Evolved Packet Core Network (EPC), through the Evolved Universal Mobile Telecommunications System Territorial Radio Access Network (E-UTRAN). At present, network changes between NGCN and EPC can be realized through N26 network interface between Access and Mobility Management Function (AMF) in NGCN and Mobility Management Entity (MME) in EPC.

However, the network handover between NGCN and EPC based on N26 network interface may result in service interruption, and some service requirements of the terminal, such as emergency call service and the like, may not be met, resulting in a decrease in reliability of network change between NGCN and EPC. The same problem exists in network handover between other different types of core networks.

### SUMMARY

Aspects of the present disclosure provide a communication method and network device to improve the reliability of network changes between different types of core networks.

In one aspect of the present disclosure, a communication method is provided, which includes that:

a first network device acquires behavior decision information of a terminal, wherein the behavior decision information includes at least one of terminal capability information of the terminal, service requirement information initiated by the terminal, service quality information initiated by the terminal and user subscription information of the terminal;

the first network device sends first indication information to the terminal according to the behavior decision information to instruct the terminal to execute a specific mobility process.

In another aspect of the present disclosure, a first network device is provided, which comprises:

an acquisition unit configured to acquire behavior decision information of a terminal, wherein the behavior decision information includes at least one of terminal capability information of the terminal, service requirement information initiated by the terminal, service quality information initiated by the terminal, and user subscription information of the terminal;

a sending unit configured to send first indication information to the terminal according to the behavior decision information to instruct the terminal to execute a specific mobility process.

According to the above technical scheme, in the implementation of the present disclosure, a first network device acquires behavior decision information of a terminal, wherein the behavior decision information includes at least one of terminal capability information of the terminal, service requirement information initiated by the terminal, service quality information initiated by the terminal and user subscription information of the terminal, so that the first network device can send first indication information to the terminal according to the behavior decision information, so as to instruct the terminal to execute a specific mobility process. Since the first network device instructs the terminal to execute the specific mobility process without only depending on whether a network interface exists between different types of core networks any longer, but in combination with the behavior decision information of the terminal, the terminal can implement network handover without service interruption on the basis of two different types of core networks registered by the terminal in the case where a network interface exists between different types of core networks, thereby improving the reliability of network change between different types of core networks.

### BRIEF DESCRIPTION OF DRAWINGS

In order to describe technical solutions of implementations of the present disclosure more clearly, the drawings to be used in the description of the implementations or the related art will be simply introduced below. Apparently, the drawings described below are some implementations of the present disclosure, and one skilled in the art can obtain other drawings according to these drawings without paying an inventive effort.

FIG. 1 is a schematic flow chart of a communication method according to an implementation of the present disclosure.

FIG. 2 is a schematic structural diagram of a first network device according to another implementation of the present disclosure.

### DETAILED DESCRIPTION

In order to make the purpose, technical solutions and advantages of implementations of the present disclosure more clear, the technical solutions in the implementations of the present disclosure will be described clearly and completely in the following with reference to the drawings in the implementations of the present disclosure. Apparently, the described implementations are parts, but not all, of the implementations of the present disclosure. Based on the implementations of the present disclosure, all other implementations obtained by a person of ordinary skill in the art without paying an inventive effort should fall within the protection scope of the present disclosure.

In addition, the term “and/or” in this specification describes only an association relationship for describing associated objects and represents that three relationships may exist. For example, A and/or B may represent the following three cases: Only A exists, both A and B exist, and only B exists. In addition, the symbol “/” in this document generally indicates that objects of the former and the latter connected by “/” has an “or” relationship.

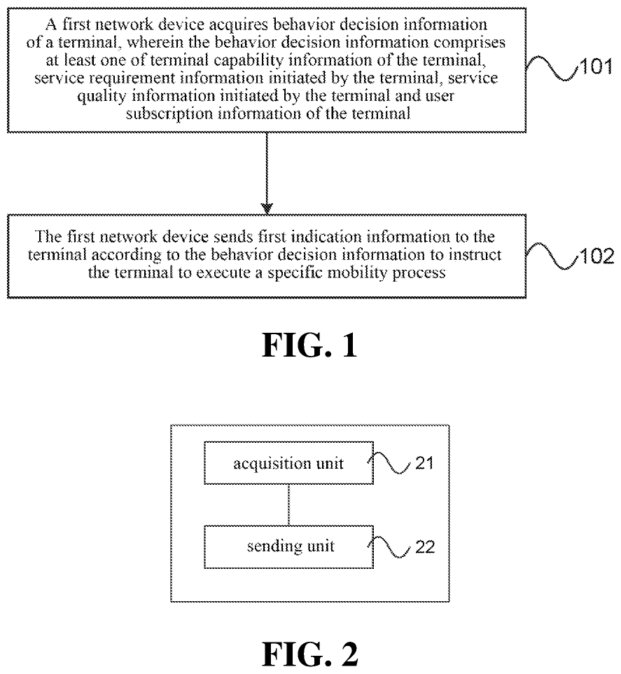

FIG. 1 is a schematic flow chart of a communication method according to an implementation of the present disclosure, as shown in FIG. 1.

In 101, a first network device acquires behavior decision information of a terminal, wherein the behavior decision information comprises at least one of terminal capability information of the terminal, service requirement information initiated by the terminal, service quality information initiated by the terminal and user subscription information of the terminal.

In 102, the first network device sends first indication information to the terminal according to the behavior decision information to instruct the terminal to execute a specific mobility process.

In the present disclosure, the specific mobility process may include, but is not limited to, a dual wireless process, a dual registration process, a dual connectivity process, or a mobility process not based on a network interface, and this implementation is not particularly limited to this.

The dual wireless process refers to a process in which the terminal executes the dual wireless process and enters the dual wireless mode. Dual wireless mode means that the terminal can connect to two types of wireless access networks simultaneously, namely wireless access network 1 and wireless access network 2, through two radio frequency units, namely radio frequency unit 1 and radio frequency unit 2 respectively. Each wireless access network of the two types of wireless access networks may be connected to one type of core network respectively, or may also be connected to the same core network, which is not particularly limited in this implementation. For example, the terminal can connect to NG-RAN and E-UTRAN respectively through two radio frequency units.

The dual registration process refers to a process in which the terminal performs the dual registration process and enters the dual registration mode. Dual registration mode means that the terminal can be simultaneously connected to two types of wireless access networks, i.e. wireless access network 1 and wireless access network 2. Each wireless access network of the two types of wireless access networks is connected to one type of core network respectively. The terminal can be connected to the two types of wireless access networks simultaneously through one radio frequency unit or through two radio frequency units respectively. For example, the terminal may access a 5G core network, namely NGCN, through NG-RAN, and may also access a 4G core network, namely EPC, through E-UTRAN.

The dual connectivity process refers to a capability of terminal to enter the dual connectivity mode by performing the dual connectivity process. Dual connectivity mode means that the terminal can simultaneously connect to two types of wireless access networks, namely wireless access network 1 and wireless access network 2, and each wireless access network of the two types of wireless access networks is connected to the same core network. The terminal can be connected to the two types of wireless access networks simultaneously through one radio frequency unit or through two radio frequency units respectively. For example, the terminal may access a 5G core network, namely NGCN, through NG-RAN and E-UTRAN, or may also access a 4G core network, namely EPC, through NG-RAN and E-UTRAN.

It should be noted that the first network device involved in the present disclosure may be a mobility management device, for example, an Access and Mobility Management Function (AMF) entity and a Session Management Function (SMF) entity in NGCN, or, for example, a Mobility Management Entity (MME) or the like in EPC, or may also be an access network device, for example, an Evolved NodeB (eNB) in E-UTRAN, or for another example, a 5G base station, namely, gNB, or the like in NG-RAN.

The core idea of the present disclosure is that the first network device determines whether to instruct the terminal to execute a specific mobility process by acquiring the behavior decision information of the terminal, instead of instructing the terminal to execute a specific mobility process depending only on whether a network interface exists between different types of core networks, so that the terminal can implement network handover without service interruption on the basis of two different types of core networks registered by the terminal in the case where a network interface exists between different types of core networks, thereby improving the reliability of network change between different types of core networks.

It should be noted that this implementation can be applied to network changes between different types of core networks, for example, network changes from 5G core network NGCN to 4G core network EPC, or network changes from 4G core network EPC to 5G core network NGCN, or network changes from 5G core network NGCN to 3G core network, which is not particularly limited in this implementation.

Optionally, in one possible implementation of this implementation, the terminal capability information may include but is not limited to at least one of the following information:

capability information on whether a specific mobility process is supported; and

capability information on whether a mobility process not based on network interface is supported, for example, N26 network interface between AMF in NGCN and MME in EPC, etc.

Optionally, in one possible implementation of this implementation, in 101, the first network device can specifically acquire behavior decision information of the terminal in a variety of ways.

In a specific implementation process, the first network device receives the terminal capability information of the terminal sent by the terminal through a registration process initiated by the terminal.

The registration process here refers to a registration process initiated by the terminal in a source system, i.e., at least one of a source access network and a source core network.

Specifically, the first network device may specifically receive terminal capability information of the terminal sent by the terminal through at least one of a registration request message and a location update message.

The registration request message may include, but is not limited to, at least one of the following types of registration request message:

initial registration type;

update registration type; and

emergency service type.

In another specific implementation process, the first network device receives the service requirement information initiated by the terminal sent by the terminal through a service process initiated by the terminal.

Specifically, the first network device can specifically receive the service requirement information initiated by the terminal sent by the terminal through at least one of a service connectivity establishment request message and a service connectivity modification message.

The service requirement information may include but is not limited to at least one of the following information:

adopting a specific mobility process;

adopting a mobility process not based on network interface, such as N26 network interface between AMF in NGCN and MME in EPC; and

delay requirement information of the service during a process of network change.

In another specific implementation process, the first network device acquires at least one of user subscription information of the terminal and service quality information initiated by the terminal, such as delay requirement information in Quality of Service (QoS) information of service connectivity , based on the service process initiated by the terminal.

Optionally, in one possible implementation of this implementation, in 102, the first indication information sent by the first network device to the terminal may instruct the terminal to execute a specific mobility process.

Specifically, the first network device may send the first indication information to the terminal through at least one of a registration reply message and a location update reply message.

The registration reply message may include, but is not limited to, at least one of the following types of registration reply messages:

initial registration type;

update registration type; and

emergency service type.

In this implementation, the first indication information may include but is not limited to at least one of the following indications:

indication of a specific mobility process; and

indication of a mobility process not based on network interface, e.g., N26 network interface between AMF in NGCN and MME in EPC, etc.

In this case, after receiving the first indication information, the terminal can use measurement configuration information to execute the specific mobility process.

The specific mobility process here refers to a registration process initiated by the terminal in a target system, i.e., at least one of a target access network and a target core network.

While executing the specific mobility process, the terminal can establish a service connectivity for all services of the terminal in the target system, or can also establish a service connectivity for part of services of the terminal in the target system, or can also establish a service connectivity for services, which meet specific delay requirement information, of the terminal in the target system, which is not particularly limited in this implementation.

The measurement configuration information adopted by the terminal may include but is not limited to the following information:

a link quality of a target access network is greater than or equal to a first threshold; or

the link quality of the target access network is greater than or equal to the first threshold, and a link quality of a source access network is less than a second threshold.

In a specific implementation process, the terminal can specifically obtain measurement configuration information according to preset configuration data.

In another specific implementation process, the first network device may further send second indication information to the second network device to instruct the terminal to perform a specific mobility process.

Further, after the first network device sends second indication information to the second network device to instruct the terminal to perform the specific mobility process, the second network device may further send measurement configuration information to the terminal for the terminal to perform a specific mobility process.

For example, the second network device may be an Evolved NodeB (eNB) in E-UTRAN.

Or, for another example, the second network device may be a 5G base station, namely gNB, etc., in NG-RAN.

In this implementation, a first network device acquires behavior decision information of a terminal, wherein the behavior decision information comprises at least one of terminal capability information of the terminal, service requirement information initiated by the terminal, service quality information initiated by the terminal and user subscription information of the terminal, so that the first network device can send first indication information to the terminal according to the behavior decision information, so as to instruct the terminal to execute a specific mobility process. Since the first network device instructs the terminal to execute the specific mobility process without only depending on whether a network interface exists between different types of core networks any longer, but in combination with the behavior decision information of the terminal, the terminal can implement network handover without service interruption on the basis of two different types of core networks registered by the terminal in the case where a network interface exists between different types of core networks, thereby improving the reliability of network change between different types of core networks. It should be noted that for sake of conciseness, the aforementioned method implementations may be expressed as a series of act combinations, but one skilled person in the art should know that the present disclosure is not limited by the described sequence of acts, since according to the present disclosure, some acts can be performed with other sequences or simultaneously. Secondly, one skilled person in the art should also know that the implementations described in the specification are all preferred implementations, and the acts and modules involved are not always necessary for the present disclosure.

In the above-mentioned implementations, the description of each implementation has its own emphasis, a part which is not described in detail in an implementation can be referred to related descriptions in other implementations.

FIG. 2 is a schematic structural diagram of a first network device according to another implementation of the present disclosure, as shown in FIG. 2. The first network device of this implementation may include an acquisition unit 21 and a sending unit 22. The acquisition unit 21 is configured to acquire behavior decision information of a terminal, wherein the behavior decision information comprises at least one of terminal capability information of the terminal, service requirement information initiated by the terminal, service quality information initiated by the terminal, and user subscription information of the terminal; the sending unit 22 is configured to send first indication information to the terminal according to the behavior decision information to instruct the terminal to execute a specific mobility process.

In the present disclosure, the specific mobility process may include, but is not limited to, a dual wireless process, a dual registration process, a dual connectivity process, or a mobility process not based on a network interface, and this implementation is not particularly limited to this.

The dual wireless process refers to a process in which the terminal executes the dual wireless process and enters the dual wireless mode. Dual wireless mode means that the terminal can connect to two types of wireless access networks simultaneously, namely wireless access network 1 and wireless access network 2, through two radio frequency units, namely radio frequency unit 1 and radio frequency unit 2 respectively. However, each wireless access network of the two types of wireless access networks may be connected to one type of core network respectively, or may also be connected to the same core network, which is not particularly limited in this implementation. For example, the terminal can connect to NG-RAN and E-UTRAN respectively through two radio frequency units.

The dual registration process refers to a process in which the terminal performs the dual registration process and enters the dual registration mode. Dual registration mode means that the terminal can be simultaneously connected to two types of wireless access networks, i.e. wireless access network 1 and wireless access network 2, and each wireless access network of the two types of wireless access networks is connected to one type of core network respectively. The terminal can be connected to the two types of wireless access networks simultaneously through one radio frequency unit or through two radio frequency units respectively. For example, the terminal may access a 5G core network, namely NGCN, through NG-RAN, and may also access a 4G core network, namely EPC, through E-UTRAN.

The dual connectivity process refers to a capability of terminal to enter the dual connectivity mode by performing the dual connectivity process. Dual connectivity mode means that the terminal can simultaneously connect to two types of wireless access networks, namely wireless access network 1 and wireless access network 2, and each wireless access network of the two types of wireless access networks is connected to the same core network. The terminal can be connected to the two types of wireless access networks simultaneously through one radio frequency unit or through two radio frequency units respectively. For example, the terminal may access a 5G core network, namely NGCN, through NG-RAN and E-UTRAN, or may also access a 4G core network, namely EPC, through NG-RAN and E-UTRAN.

It should be noted that the first network device involved in the present disclosure may be a mobility management device, for example, an Access and Mobility Management Function (AMF) entity and a Session Management Function (SMF) entity in NGCN, or, for example, a Mobility Management Entity (MME) or the like in EPC, or may also be an access network device, for example, an Evolved NodeB (eNB) in E-UTRAN, or for another example, a 5G base station, namely, gNB, or the like in NG-RAN.

The core idea of the present disclosure is that the first network device determines whether to instruct the terminal to execute a specific mobility process by acquiring the behavior decision information of the terminal, instead of instructing the terminal to execute a specific mobility process depending only on whether a network interface exists between different types of core networks, so that the terminal can implement network handover without service interruption on the basis of two different types of core networks registered by the terminal in the case where a network interface exists between different types of core networks, thereby improving the reliability of network change between different types of core networks.

It should be noted that this implementation can be applied to network changes between different types of core networks, for example, network changes from 5G core network NGCN to 4G core network EPC, or network changes from 4G core network EPC to 5G core network NGCN, or network changes from 5G core network NGCN to 3G core network, which is not particularly limited in this implementation.

Optionally, in one possible implementation of this implementation, the terminal capability information may include but is not limited to at least one of the following information:

capability information on whether a specific mobility process is supported; and

capability information on whether a mobility process not based on network interface is supported, for example, N26 network interface between AMF in NGCN and MME in EPC, etc.

Optionally, in one possible implementation of this implementation, the acquisition unit 21 can be specifically configured to:

receive terminal capability information of the terminal sent by the terminal through a registration process initiated by the terminal, and/or

receive service requirement information initiated by the terminal sent by the terminal through a service process initiated by the terminal; and/or

acquire at least one of service quality information initiated by the terminal and user subscription information of the terminal based on the service process initiated by the terminal.

Optionally, in one possible implementation of this implementation, the first indication information sent by the sending unit 22 to the terminal may include but is not limited to at least one of the following indications:

indication of a specific mobility process; and

indication of a mobility process not based on network interface.

Optionally, in one possible implementation of this implementation, the sending unit 22 may be further configured to send second indication information to a second network device, and the terminal performs a specific mobility process.

The measurement configuration information adopted by the terminal may include but is not limited to the following information:

the link quality of the target access network is greater than or equal to a first threshold; or

the link quality of the target access network is greater than or equal to the first threshold, and the link quality of the source access network is less than a second threshold.

It should be noted that the functions of the first network device in the implementation corresponding to FIG. 1 can be implemented by the first network device provided in this implementation. Relevant contents in the corresponding implementation of FIG. 1 may be referred to for detailed descriptions, which are not repeated here.

In this implementation, the acquisition unit acquires behavior decision information of a terminal, wherein the behavior decision information comprises at least one of terminal capability information of the terminal, service requirement information initiated by the terminal, service quality information initiated by the terminal, and user subscription information of the terminal, so that the sending unit can send first indication information to the terminal according to the behavior decision information to instruct the terminal to execute a specific mobility process. Since the first network device instructs the terminal to execute the specific mobility process without only depending on whether a network interface exists between different types of core networks any longer, but in combination with the behavior decision information of the terminal, the terminal can implement network handover without service interruption on the basis of two different types of core networks registered by the terminal in the case where a network interface exists between different types of core networks, thereby improving the reliability of network change between different types of core networks.

Those skilled in the art can clearly understand that, for convenience and conciseness of the description, the specific working processes of the system, apparatus and unit described above may refer to the corresponding processes in the above method implementations, which are not described herein again.

In several implementations provided by the present disclosure, it should be understood that the disclosed systems, apparatuses and methods may be implemented in other ways. For example, the apparatus implementations described above are only illustrative, for example, the division of the units is only a logical function division, and there may be other division manners in actual implementation, for example, multiple units or components may be combined or integrated into another system, or some features may be ignored or not executed. On the other hand, the mutual coupling or direct coupling or communication connection shown or discussed may be indirect coupling or communication connection through some interfaces, apparatuses or units, and may be in electrical, mechanical or other forms.

The unit described as a separate component may or may not be physically separated, and the component shown as a unit may or may not be a physical unit, i.e., it may be located in one place or may be distributed over multiple network units. Some or all of the units may be selected according to actual needs to achieve the purpose of the implementations.

In addition, various functional units in various implementations of the present disclosure may be integrated in one processing unit, or the various units may be physically present separately, or two or more units may be integrated in one unit. The integrated units can be implemented in the form of hardware or in the form of hardware plus software functional units.

Finally, it should be noted that the above implementations are only used to illustrate the technical solutions of the present disclosure, but not to limit the present disclosure. Although the present disclosure has been described in detail with reference to the foregoing implementations, it should be understood by those skilled in the art that the technical solutions described in the foregoing implementations may be modified or some of technical features thereof may be equally substituted. And, these modifications or substitutions do not make the essence of the corresponding technical solution depart from the spirit and scope of the technical solutions of various implementations of the present disclosure.

What is claimed is:

1. A method for communication, comprising:
acquiring, by a first network device, behavior decision information of a terminal, wherein the behavior decision information comprises at least one of: terminal capability information of the terminal, service requirement information initiated by the terminal, service quality information initiated by the terminal, or user subscription information of the terminal; and
sending, by the first network device, first indication information to the terminal according to the behavior decision information to instruct the terminal to execute a specific mobility process.

2. The method according to claim 1, wherein the specific mobility process comprises a dual wireless process, a dual registration process, a dual connectivity process, or a mobility process not based on a network interface.

3. The method according to claim 1, wherein the terminal capability information comprises at least one of the following information:
capability information on whether a specific mobility process is supported; or
capability information on whether a mobility process not based on a network interface is supported.

4. The method according to claim 1, wherein acquiring, by the first network device, the behavior decision information of the terminal comprises at least one of:
receiving, by the first network device, the terminal capability information of the terminal sent by the terminal through a registration process initiated by the terminal;
receiving, by the first network device, the service requirement information initiated by the terminal sent by the terminal through a service process initiated by the terminal; or
acquiring, by the first network device, at least one of the service quality information initiated by the terminal and user subscription information of the terminal based on a service process initiated by the terminal.

5. The method according to claim 1, wherein the first indication information comprises at least one of the following indications:
indication of a specific mobility process; or
indication of a mobility process not based on a network interface.

6. The method according to claim 1, further comprising:
after the first network device acquires the behavior decision information of the terminal,
sending, by the first network device, second indication information to a second network device to instruct the terminal to perform a specific mobility process.

7. The method according to claim 6, further comprising:
after the first network device sends the second indication information to the second network device to instruct the terminal to execute the specific mobility process,
sending, by the second network device, measurement configuration information to the terminal for the terminal to perform a specific mobility process.

8. The method according to claim 7, wherein the measurement configuration information comprises the following information:
a link quality of a target access network is greater than or equal to a first threshold; or
a link quality of a target access network is greater than or equal to a first threshold, and a link quality of a source access network is less than a second threshold.

9. A first network device, comprising:
a receiver configured to acquire behavior decision information of a terminal, wherein the behavior decision information comprises at least one of terminal capability information of the terminal, service requirement information initiated by the terminal, service quality information initiated by the terminal, and user subscription information of the terminal; and
a transmitter configured to send first indication information to the terminal according to the behavior decision information to instruct the terminal to execute a specific mobility process.

10. The first network device according to claim 9, wherein the specific mobility process comprises a dual wireless process, a dual registration process, a dual connectivity process, or a mobility process not based on a network interface.

11. The first network device according to claim 9, wherein the terminal capability information comprises at least one of the following information:
capability information on whether a specific mobility process is supported; or
capability information on whether a mobility process not based on a network interface is supported.

12. The first network device according to claim 9, wherein the receiver is specifically configured to perform at least one of:
receiving the terminal capability information of the terminal sent by the terminal through a registration process initiated by the terminal,
receiving the service requirement information initiated by the terminal sent by the terminal through a service process initiated by the terminal; or
acquiring at least one of the service quality information initiated by the terminal and the user subscription information of the terminal based on the service process initiated by the terminal.

13. The first network device according to claim 9, wherein the first indication information comprises at least one of the following indications:
indication of a specific mobility process; or
indication of a mobility process not based on a network interface.

14. The first network device according to claim 9, wherein the transmitter is further configured to
send second indication information to a second network device to instruct the terminal to perform a specific mobility process, wherein the second network device sends measurement configuration information to the terminal for the terminal to perform a specific mobility process.

15. The first network device according to claim 14, wherein the measurement configuration information comprises the following information:
a link quality of a target access network is greater than or equal to a first threshold; or
a link quality of a target access network is greater than or equal to a first threshold, and a link quality of a source access network is less than a second threshold.
